(19) United States
(12) Patent Application Publication
(10) Pub. No.: US 2017/0324790 A1
(43) Pub. Date: Nov. 9, 2017

(54) METHODS, SYSTEMS, AND MEDIA FOR PRESENTING A NOTIFICATION OF PLAYBACK AVAILABILITY

(71) Applicant: Google Inc., Mountain View, CA (US)

(72) Inventors: Jun Li, Zurich (CH); Suman Basak, Zurich (CH)

(21) Appl. No.: 15/146,479

(22) Filed: May 4, 2016

(51) Int. Cl. H04L 29/06; G06F 3/14; G06F 3/0481; G06F 3/0484; H04L 29/08

(52) U.S. Cl. CPC H04L 65/4084; H04L 67/327; H04L 67/306; G06F 3/04812; G06F 3/0484; G06F 3/14

(57) ABSTRACT

Methods, systems, and media for presenting a notification indicating playback availability are provided. In some implementations, the method comprises: receiving interaction data corresponding to a user account authenticated on a first display device that is presenting a media content item, wherein the interaction data is associated with the first display device and a second display device; determining a user type based on the received interaction data; receiving local contextual data corresponding to the user account, wherein the local contextual data includes mobile application state information, media playback information, and connection information associated with the first display device and the second display device; determining that a notification of playback availability from of plurality of notifications is to be presented on the first display device based at least in part on the received interaction data, the determined user type, and the received local contextual data; and causing the notification to be presented on the first display device along with the media content item.

### TECHNICAL FIELD

The disclosed subject matter relates to methods, systems, and media for presenting a notification of playback availability.

### BACKGROUND

Many users want to stream media content (such as music, videos, movies, television programs, etc.) from a mobile device to a larger display, such as a television. However, users may have difficulty learning or remembering how to cause the media content to be presented on the larger display.

Accordingly, it is desirable to provide new methods, systems, and media for presenting a notification of playback availability.

### SUMMARY

Methods, systems, and media for presenting a notification of playback availability are provided. In accordance with some implementations of the disclosed subject matter, a method for presenting a notification of playback availability is provided, the method comprising: receiving interaction data corresponding to a user account authenticated on a first display device that is presenting a media content item, wherein the interaction data is associated with the first display device and a second display device; determining a user type based on the received interaction data; receiving local contextual data corresponding to the user account, wherein the local contextual data includes mobile application state information, media playback information, and connection information associated with the first display device and the second display device; determining that a notification of playback availability from of plurality of notifications is to be presented on the first display device based at least in part on the received interaction data, the determined user type, and the received local contextual data; and causing the notification to be presented on the first display device along with the media content item.

In accordance with some implementations of the disclosed subject matter, a system for presenting a notification of playback availability is provided, the system comprising: a hardware processor that is programmed to: receive interaction data corresponding to a user account authenticated on a first display device that is presenting a media content item, wherein the interaction data is associated with the first display device and a second display device; determine a user type based on the received interaction data; receive local contextual data corresponding to the user account, wherein the local contextual data includes mobile application state information, media playback information, and connection information associated with the first display device and the second display device; determine that a notification of playback availability from of plurality of notifications is to be presented on the first display device based at least in part on the received interaction data, the determined user type, and the received local contextual data; and cause the notification to be presented on the first display device along with the media content item.

In accordance with some implementations of the disclosed subject matter, a non-transitory computer-readable medium containing computer executable instructions that, when executed by a processor, cause the processor to perform a method for presenting a notification of playback availability is provided. The method comprises: receiving interaction data corresponding to a user account authenticated on a first display device that is presenting a media content item, wherein the interaction data is associated with the first display device and a second display device; determining a user type based on the received interaction data; receiving local contextual data corresponding to the user account, wherein the local contextual data includes mobile application state information, media playback information, and connection information associated with the first display device and the second display device; determining that a notification of playback availability from of plurality of notifications is to be presented on the first display device based at least in part on the received interaction data, the determined user type, and the received local contextual data; and causing the notification to be presented on the first display device along with the media content item.

In accordance with some implementations of the disclosed subject matter, a system for presenting a notification of playback availability is provided, the system comprising: means for receiving interaction data corresponding to a user account authenticated on a first display device that is presenting a media content item, wherein the interaction data is associated with the first display device and a second display device; determining a user type based on the received interaction data; means for receiving local contextual data corresponding to the user account, wherein the local contextual data includes mobile application state information, media playback information, and connection information associated with the first display device and the second display device; means for determining that a notification of playback availability from of plurality of notifications is to be presented on the first display device based at least in part on the received interaction data, the determined user type, and the received local contextual data; and means for causing the notification to be presented on the first display device along with the media content item.

In some implementations, the system further comprises: means for selecting a notification type from the plurality of notifications based at least in part on a device type associated with the first display device.

In some implementations, the user type indicates a likelihood that the user will transfer playback of the media content item to the second display device.

In some implementations, the media playback information included in the local contextual data indicates a resolution of the media content item.

In some implementations, the connection data included in the local contextual data indicates a distance between the first display device and the second display device.

In some implementations, the system further comprises means for determining that a cursor associated with the first display device is positioned at a predetermined location of a display of the first display device, wherein the notification is presented in response to the determination.

In some implementations, the system further comprises: means for determining that a predetermined duration of time has elapsed since the notification was presented on the first display device; and in response to determining that the predetermined duration of time has elapsed, means for causing the notification to no longer be presented on the first display device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a schematic diagram of an example of a system for presenting a notification of playback availability in accordance with some implementations of the disclosed subject matter.

FIG. 2 shows an example of hardware that can be used in a server and/or a user device in accordance with some implementations of the disclosed subject matter.

FIG. 3 shows an example of a process for presenting a notification of playback availability in accordance with some implementations of the disclosed subject matter.

FIG. 4 shows an example of a user interface for presenting a notification of playback ability of a second user device in accordance with some implementations of the disclosed subject matter.

### DETAILED DESCRIPTION

In accordance with various implementations, mechanisms (which can include methods, systems, and media) for presenting a notification of playback availability are provided.

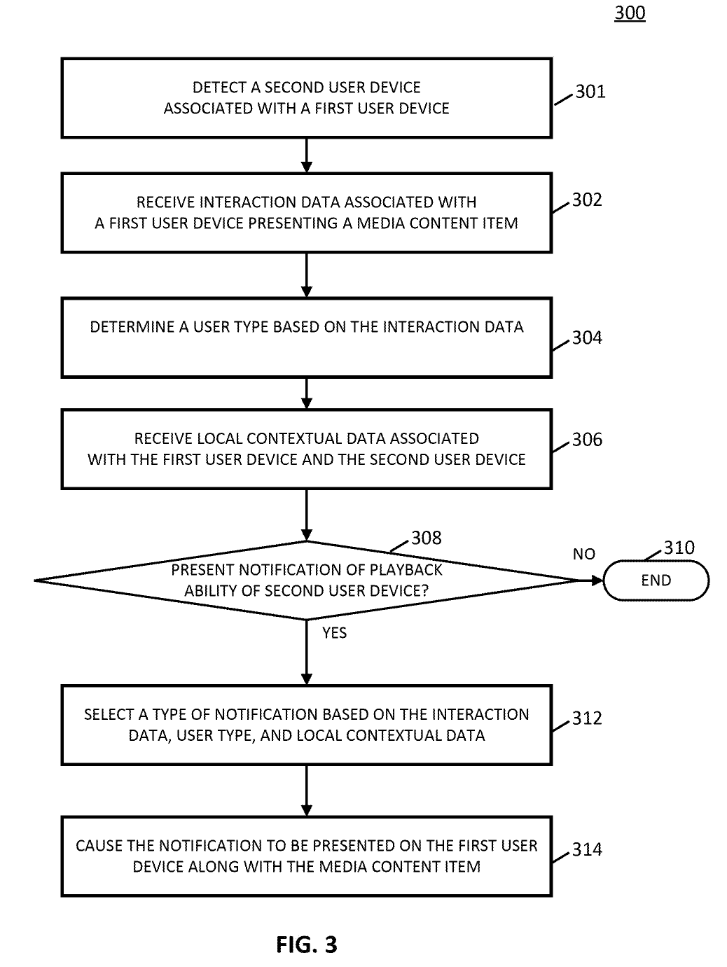

In accordance with some implementations, the mechanisms described herein can cause media content to be presented on a first user device (e.g., a mobile phone, a tablet computer, a laptop computer, a wearable computer, and/or any other suitable type of user device), can detect and connect to a second user device (e.g., a television, a projector, and/or any other suitable type of user device) associated with the first user device, and can cause a notification to be presented on the first user device indicating that the second user device is capable of playback of the media content. In some implementations, the second user device can be detected using any suitable technique or combination of techniques, as described below in connection with FIG. 3. In some implementations, the notification can indicate directions for transferring playback of the media content. For example, in some implementations, the directions can indicate an icon included in a user interface on the first user device that, when selected, causes playback of the media content to be transferred to the second user device.

Note that, in some implementations, playback of the media content can be transferred to the second user device using any suitable technique or combination of techniques. For example, in some implementations, a streaming media content device can be connected to and/or integrated with the second user device, and the streaming media content device can receive communications from the first user device (e.g., through a WiFi network, a BLUETOOTH network, a 3G network, a 4G/LTE network, the Internet, and/or through any other suitable communications network) and can cause the media content to be presented on the second user device in response to receiving the communications from the first user device. In some implementations, the streaming media content device can use any suitable protocols (e.g., adaptive bitrate streaming, HTTP live streaming, and/or any other suitable protocols) to cause the media content to be presented on the second user device.

In some implementations, the mechanisms can determine whether to present the notification based on any suitable information. For example, in some implementations, the mechanisms can determine whether to present the notification based on a type of content being presented on the first user device, a distance between the first user device and the second user device, a user's previous actions relating to transferring playback of media content from the first user device to the second user device, and/or any other suitable information.

In some implementations, the mechanisms can additionally select a notification type prior to causing the notification to be presented. In some implementations, the notification type can include a notification that is presented in response to determining that a cursor is positioned in a particular location within a user interface on the first user device, a notification that is overlaid on a user interface on the first user device, and/or any other suitable notification format. In some implementations, the mechanisms can select the notification type based on a device type associated with the first user device, and/or any other suitable information.

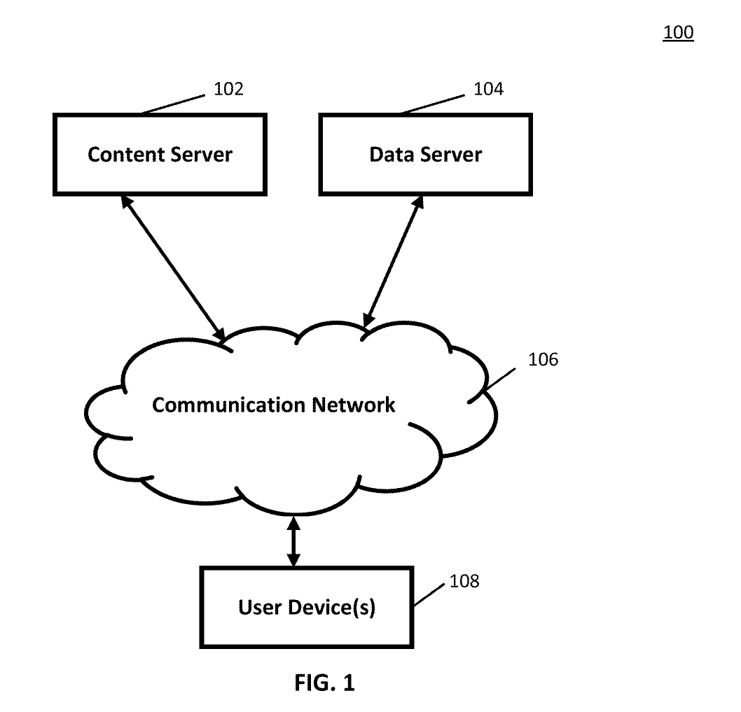

Turning to FIG. 1, an example 100 of hardware for presenting a notification of playback ability of a second user device connected to a first user device that can be used in accordance with some implementations of the disclosed subject matter is shown. As illustrated, hardware 100 can include one or more servers, such as a media server 102, a data server 104, a communication network 106, and one or more user devices 108.

Media server 102 can be any suitable server for storing content and delivering the content to a user device 108 in some implementations. For example, media server 102 can be a server that streams media content to a first user device via communication network 106. As a more particular example, in some implementations, media server 102 can stream media content to a first user device in response to receiving a request for the media content from the first user device. Content provided by media server 102 can be any suitable content, such as video content, audio content, television programs, movies, cartoons, sound effects, audiobooks, web pages, news articles, streaming live content (e.g., a streaming radio show, a live concert, and/or any other suitable type of streaming live content), electronic books, search results and/or any other suitable type of content. Content can be created and uploaded to media server 102 by any suitable entity. In some implementations, media server 102 can be omitted.

Data server 104 can be any suitable server for storing information related to a user account, a user's previous actions relating to devices used to view content, and/or any other suitable information. For example, in some implementations, data server 104 can store information indicating the frequency with which a user of a first user device causes media content to be presented on a second user device connected to the first user device. As another example, in some implementations, data server 104 can store information indicating identities of user devices frequently connected to a first user device that are capable of initiating playback of a media content item. In some implementations, the information can be used to determine whether a notification of playback ability of a second user device connected to a first user device is to be presented on the first user device, as shown in and described below in connection with FIG. 3. In some implementations, data sever 104 can be omitted. Note that, in some implementations, consent from a user can be requested before storing information on data server 104. Additionally or alternatively, in some implementations, the user can select and/or modify the types of information stored on data server 104.

Communication network 106 can be any suitable combination of one or more wired and/or wireless networks in some implementations. For example, communication network 106 can include any one or more of the Internet, a mobile data network, a satellite network, a local area network, a wide area network, a telephone network, a cable television network, a WiFi network, a WiMax network, and/or any other suitable communication network.

User device(s) 108 can include any one or more user devices suitable for receiving messages and/or presenting content. For example, in some implementations, user device(s) 108 can include mobile devices, such as a mobile phone, a tablet computer, a laptop computer, a vehicle (e.g., a car, a boat, an airplane, or any other suitable vehicle) entertainment system, a portable media player, or any other suitable mobile device. As another example, in some implementations, user device(s) 108 can include non-mobile devices such as a desktop computer, a set-top box, a television, a streaming media player, a game console, or any other suitable non-mobile device. Note that, in the implementations described herein, a first user device and a second user device are described, and the first user device and the second user device can each be any of the types of user devices described above.

Although media server 102 and data server 104 are illustrated as separate devices, any one or more of these devices can be combined into one device in some implementations. Also, although only one each of media server 102 and data server 104 are shown in FIG. 1 to avoid over-complicating the figure, any suitable one or more of each device can be used in some implementations.

Although only one user device 108 is shown in FIG. 1 to avoid over-complicating the figure, any suitable number of each of these devices, and any suitable types of these devices, can be used in some implementations.

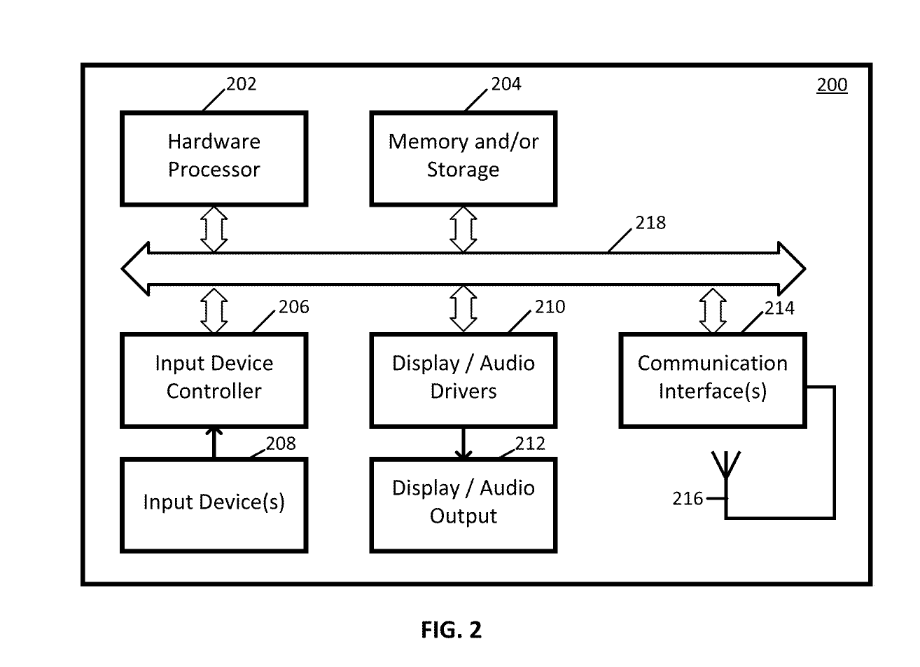

Media server 102, data server 104, and user device 108 can be implemented using any suitable hardware in some implementations. For example, in some implementations, devices 102, 104, and 108 can be implemented using any suitable general purpose computer or special purpose computer. For example, a server may be implemented using a special purpose computer. Any such general purpose computer or special purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general purpose computer or a special purpose computer in some implementations.

Memory and/or storage 204 can be any suitable memory and/or storage for storing programs, data, media content, and/or any other suitable information in some implementations. For example, memory and/or storage 204 can include random access memory, read-only memory, flash memory, hard disk storage, optical media, and/or any other suitable memory.

Input device controller 206 can be any suitable circuitry for controlling and receiving input from one or more input devices 208 in some implementations. For example, input device controller 206 can be circuitry for receiving input from a touch screen, from one or more buttons, from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output circuitries 212 in some implementations. For example, display/audio drivers 210 can be circuitry for driving an LCD display, a speaker, an LED, or any other type of output device.

Communication interface(s) 214 can be any suitable circuitry for interfacing with one or more communication networks, such as network 106 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some implementations. In some implementations, antenna 216 can be omitted when not needed.

Bus 218 can be any suitable mechanism for communicating between two or more components 202, 204, 206, 210, and 214 in some implementations.

Any other suitable components can be included in hardware 200 in accordance with some implementations.

Turning to FIG. 3, an example 300 of a process for determining whether a notification of the availability of a second user device connected to a first user device to present media content is shown in accordance with some implementations of the disclosed subject matter. In some implementations, blocks of process 300 can be implemented on the first user device (e.g., one of user device 108) and/or data server 104. Note that, in some implementations, any suitable blocks of process 300 can execute in parallel. For example, in some implementations, process 300 can detect the second user device (e.g., at block 301) while receiving interaction data (e.g., at block 302), determining a user type associated with the user devices (e.g., at block 304) and/or receiving local contextual information associated with the user devices (e.g., at block 306).

Process 300 can begin by detecting a second user device associated with a first user device at 301. In some implementations, the first user device and the second user device can be any suitable user devices. For example, in some implementations, the second user device can be one that is detected (e.g., using any suitable device detection protocol) and connected to the first user device (e.g., using any suitable communication protocol) and is capable of playback of a media content item being presented on the first user device. As a specific example, in some implementations, the first user device can be a mobile device (e.g., a mobile phone, a tablet, a laptop computer, and/or any other suitable mobile device), and the second user device can be a device suitable for media content playback (e.g., a television, a projector, audio speakers, and/or any other suitable user device).

Process 300 can discover the second user device using any suitable technique or combination of techniques, such as multicasting a message to a particular address on the network, and launching an event listener to listen for replies from devices on the network that received the multicast message. Additionally, in some implementations, an event listener associated with the device executing process 300 (e.g., the first user device) can listen for messages sent from another user device (e.g., the second user device) that may not be a response to a multicast message previously sent by such a device. Such a message can be a broadcast, multicast, or unicast message sent by the second user device. In some implementations, process 300 can discover devices at 301 in response to the first user device launching a particular application, in response to a particular user input (e.g., a user input to begin presentation of a media content item on the first user device, and/or any other suitable user input), periodically, or at any other suitable time. Note that, in some implementations, process 300 can use any specific protocols to detect and identify user devices on a local network (e.g., a local WiFi network within a user's home, and/or any other suitable local network), such as a Discovery and Launch (DIAL) Service Discovery protocol.

At 302, process 300 can receive interaction data associated with a first user device that is presenting and/or is initiating presentation of a media content item. In some implementations, playback of the media content item can be currently occurring on the first user device. Additionally or alternatively, in some implementations, the first user device can be initiating presentation of the media content item, for example, in response to receiving a user input selecting the media content item (e.g., by selecting a link corresponding to the media content item, navigating to a page corresponding to the media content item, and/or in response to any other suitable user input.

The received interaction data can indicate any suitable information associated with a user account authenticated on the first user device. For example, in some implementations, the interaction data can indicate a frequency with which a user of the first user device chooses to transfer playback of media content to a second user device connected to the first user device. As another example, in some implementations, the interaction data can indicate identities of specific user devices the user chooses for playback of media content items from a first user device. As a more particular example, in some implementations, the identities of the user devices can be indicated by information such as device type (e.g., a television, a projector, speakers, a desktop computer, and/or any other suitable device types), an Internet Protocol (IP) address, and/or any other suitable information. As yet another example, in some implementations, the interaction data can indicate times of day a user chooses to transfer playback of media content (e.g., on weekends, between 6 p.m. and 9 p.m., and/or any other suitable timing information). As still another example, in some implementations, the interaction data can indicate user locations at which a user chooses to transfer playback of media content (e.g., when the first user device is determined to be located at the user's home, and/or at any other suitable location(s)). Note that, in some implementations, the types of interaction data received and/or used by process 300 can be specified by a user of the first user device. Additionally, in some implementations, the user can update and/or modify the types of interaction data received and/or used by process 300 at any suitable time(s).

Note that, in some implementations, the interaction data can be stored locally in memory 204 of the first user device. Additionally or alternatively, in some implementations, the interaction data can be stored in memory 204 of data server 104.

Process 300 can determine a user type of a user corresponding to the user account authenticated on the first user device at 304. For example, in some implementations, the user type can indicate a likelihood that the user will transfer playback of a media content item to a second user device connected to the first user device. In some implementations, the user type can be one of several categories (e.g., “low likelihood of transferring playback,” “medium likelihood of transferring playback,” “high likelihood of transferring playback,” and/or any other suitable categories). Note that, in some implementations, any suitable number of categories can be used. In some implementations, the likelihood of transferring playback of a media content item to the second user device can be determined based on any suitable information. For example, in some implementations, the likelihood of transferring playback of the media content can be based on the interaction data received at block 302. As a more particular example, in instances where the interaction data determines that the user frequently transfers playback of media content to a particular user device (e.g., the user's television, and/or any other suitable device), process 300 can determine that there is a high likelihood of the user transferring playback of media content, particularly in instances where process 300 determines that the first user device is connected to the particular device. Note that, in some implementations, the user type can be determined and/or updated at any suitable times. For example, in some implementations, the user type can be updated every day, every week, and/or at any other suitable time intervals.

Process 300 can receive local contextual information associated with the first user device and a second user device at 306. The local contextual information can include any suitable information. For example, in some implementations, the local contextual information can indicate a state of an application available on the first user device and/or the second user device connected to the first user device. As a more particular example, in some implementations, the application can be one used for streaming and/or presenting audio and/or video content items (e.g., from a video sharing service, from a social networking service, and/or from any other suitable source). In some implementations, the local contextual information can indicate that the application is installed on the first user device and/or the second user device, the application is currently executing on the first user device and/or the second user device, and/or any other suitable information related to the application.

As another example, in some implementations, the local contextual information can indicate media playback information related to the media content being presented and/or selected for presentation on the first user device. As a more particular example, the local contextual information can indicate a type of content associated with the media content (e.g., a television program, a video clip, live-streamed video, associated with a particular type of audio file, a live-streamed radio program, an audiobook, a podcast, and/or any other suitable type of media content). As another particular example, the local contextual information can indicate a resolution of the media content (e.g., high-definition video content, and/or any other suitable resolution).

As yet another example, in some implementations, the local contextual information can indicate information about the environment in which the first user device and the second user device are currently located. As a more particular example, the local contextual information can indicate that both user device are located in the user's home (e.g., based on previously stored Global Positioning System, or GPS, coordinate, and/or based on any other suitable location information). As another more particular example, in some implementations, the local contextual information can indicate a distance (e.g., five feet, ten feet, and/or any other suitable distance) between the first user device and the second user device. In some such implementations, the distance between the first user device and the second user device can be determined based on any suitable information, such as a strength of a Wi-Fi and/or BLUETOOTH signal, and/or any other suitable connection information.

Process 300 can determine whether a notification of the ability to transfer playback of the media content item to the second user device is to be presented on the first user device at 308. In some implementations, the determination can be made based on the interaction data received at block 302, the user type determined at block 304, and/or the local contextual information received at block 306. For example, in some implementations, the determination can be made based on any suitable combination of information such as how likely the user is to transfer playback of media content, the particular type of media content being viewed on the first user device, and/or how far apart the first user device and the second user device are. As a more particular example, in instances where the user type determined at block 304 indicates that the user has a medium likelihood transferring playback to the second user device, and the local contextual information indicates that the media content is a high-definition video and that the first user device and the second user device are relatively close to each other (e.g., less than five feet apart, less than ten feet apart, and/or any other suitable distance), process 300 can determine that the notification is to be presented. As another more particular example, in instances where the user type indicates that the user has a low likelihood of transferring playback to the second user device, process 300 can determine that the notification is not to be presented. As yet another more particular example, in instances where the user type indicates that the user has a high likelihood of transferring playback to the second user device, process 300 can determine that the notification is to be presented. Note that, in some implementations, the determination can additionally or alternatively be made based on how recently other notifications have been presented. For example, in some implementations, process 300 can determine that a notification is not to be presented if a previous notification was presented within a predetermined time period (e.g., within the last hour, within the last day, and/or any other suitable time period).

Note that, in some implementations, information from different factors (e.g., interaction data, user type, and/or local contextual information) can be combined in any suitable manner. For example, in some implementations, the information can be combined using a weighted average of information associated with the different factors. Additionally, in some implementations, the weight associated with each factor can be modified, for example, in response to the user's reaction when a notification is presented. For example, in some implementations, the user's reaction can include whether the user selected or dismissed the notification, whether the user transferred playback of the media content after a notification of playback ability of the second user device was presented, and/or any other suitable information.

If, at 308, process 300 determines that a notification is not to be presented (“no” at 308), process 300 can end at 310.

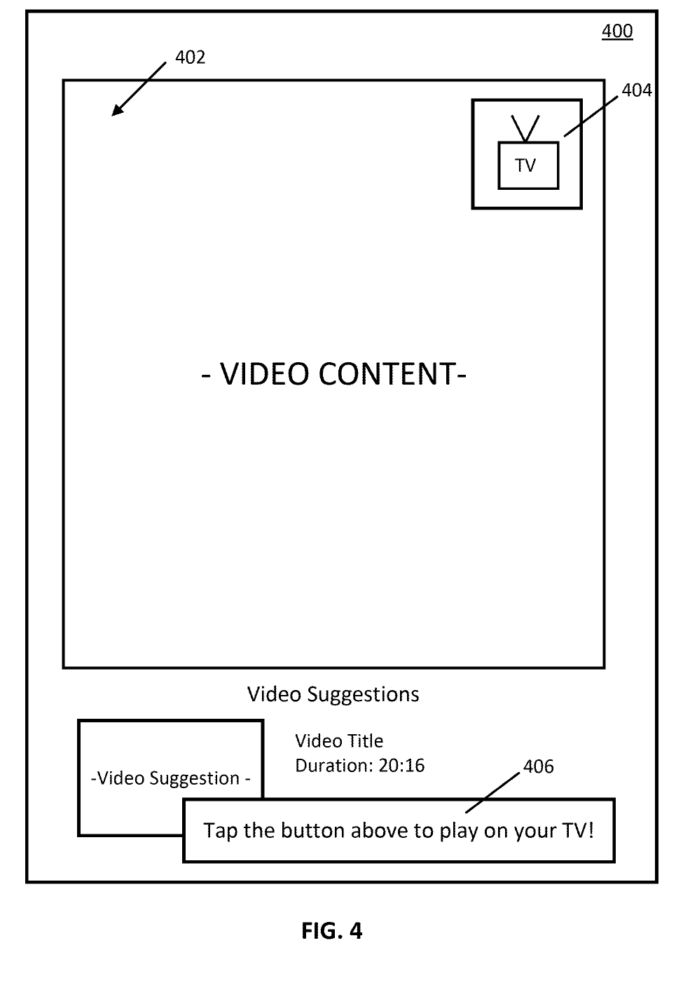

If, at 308, process 300 determines that a notification is to be presented (“yes” at 308), process 300 can select a type of notification at 312. In some implementations, any suitable type of notification can be used. For example, in some implementations, the notification can include an overlay that includes text that indicates that a second user device is available for playback of the media content and how playback can be initiated, as shown in and described below in connection with FIG. 4. In some such implementations, the notification can be dismissed in any suitable manner (e.g., by swiping the notification off a screen of the first user device, by selecting a portion of the notification on the first user device, and/or in any other suitable manner). Additionally or alternatively, in some implementations, process 300 can determine that the notification is to no longer be presented after a predetermined duration of time (e.g., five seconds, ten seconds, and/or any other suitable duration of time) elapses. As another example, in some implementations, the notification can include a text box that appears when a cursor is positioned over a particular portion of a display on the first user device. As a more particular example, in some implementations, process 300 can determine that the notification is to be presented in response to determining that a mouse cursor is positioned over a particular icon (e.g., an icon indicating availability of the second user device) and/or a particular item of text (e.g., text indicating availability of the second user device, and/or any other suitable text) presented in a user interface associated with presentation of the media content on the first user device. In some implementations, the notification can include any suitable text indicating directions for transferring playback of the media content to the second user device, as shown in FIG. 4.

Process 300 can select the type of notification based on any suitable information, including the interaction data received at block 302, the user type determined at block 304, the local contextual data received at block 306, and/or any other suitable information. For example, in some implementations, the type of notification can be determined based on a device type associated with the first user device. As a more particular example, in instances where the first user device corresponds to a device with a touchscreen (e.g., a smart phone, a tablet computer, and/or any other suitable type of user device), process 300 can determine that an overlay notification that can be interacted with via the touchscreen and/or dismissed via swiping is to be presented. As another more particular example, in instances where the first user device is associated with an input device such as a mouse, process 300 can determine that a notification that is presented in response to determining that a cursor is positioned in a particular location is to be presented.

Process 300 can cause the notification of the selected notification type to be presented on the first user device at 314. In some implementations, the notification can be presented while the media content is being presented on the first user device. An example of a user interface for presenting the notification is shown in and described below in connection with FIG. 4.

In some implementations, process 300 can cause playback of media content currently being presented on the first user device to be transferred to the second user device associated with the notification in response to determining that the notification has been selected (e.g., clicked, tapped, and/or selected in any other suitable manner) on the first user device. Playback can be transferred from the first user device to the second user device using any suitable technique or combination of techniques. For example, in some implementations, the first user device can transmit instructions to the second user device that can indicate the media content item to be presented and/or a playback position at which the media content item is to be presented. As a more particular example, in some implementations, the transmitted instructions can include a Uniform Resource Locator (URL) at which the media content item is stored. In some such implementations, the second user device can locate the specified media content item based on the received instructions and can then cause the specified media content item to be presented on the second user device.

As another example, in some implementations, the first user device can send the media content item to the second user device via any suitable communication network (e.g., a WiFi network, a BLUETOOTH network, and/or any other suitable network). Additionally or alternatively, in some implementations, the first user device can send the media content item to the second user device via a secure communication channel established between the first user device and the second user device. In some implementations, any suitable protocol can be used to transfer data associated with the media content item from the first user device to the second user device, such as adaptive bitrate streaming, HTTP live streaming, user datagram protocol (UDP), and/or any other suitable protocol. The second user device can then cause the media content item to be presented on the second user device. In some implementations, the second user device can store and receive information in a buffer before and/or during presentation of the media content item.

Note that, in some implementations, process 300 can cause presentation of the media content item to be inhibited on the first user device when presentation of the media content item begins on the second user device. Additionally, in some implementations, process 300 can turn the first user device off after inhibiting presentation of the media content item.

Turning to FIG. 4, an example 400 of a user interface for presenting a notification of playback ability of a second user device connected to a first user device is shown in accordance with some implementations of the disclosed subject matter. As illustrated, user interface 400 includes video content 402, playback indicator 404, and notification 406. In some implementations, user interface 400 can be presented on a first user device.

Video content 402 can include any suitable video content being presented on the first user device and/or selected for presentation on the first user device. In some implementations, video content 402 can be presented in a video player window which can include any suitable controls, such as a pause control, a volume control, rewind and/or fast-forward controls, and/or any other suitable controls. Note that, in some implementations, the first user device can present audio content and/or any other suitable type of media content.

Playback indicator 404 can be any suitable icon or other type of indicator that indicates that a second user device that is capable of playback of video content 402 has been detected and/or connected to the first user device. As shown in user interface 400, in some implementations, playback indicator 404 can indicate a device type associated with the second user device. In some implementations, selection of playback indicator 404 can cause playback of video content 402 to begin on the second user device indicated by playback indicator 404.

Notification 406 can be any suitable notification that indicates that the second user device is available and capable of playback of video content 402. As described above in connection with block 314 of FIG. 3, notification 406 can be presented as an overlay over other content in user interface 400, as shown in FIG. 4. In some implementations, notification 406 can be dismissed from user interface 400, for example, by swiping notification 406 off the display of the first user device.

It should be understood that at least some of the above described blocks of the process of FIG. 3 can be executed or performed in any order or sequence not limited to the order and sequence shown in and described in the figure. Also, some of the above blocks of the process of FIG. 3 can be executed or performed substantially simultaneously where appropriate or in parallel to reduce latency and processing times. Additionally or alternatively, some of the above described blocks of the process of FIG. 3 can be omitted.

In some implementations, any suitable computer readable media can be used for storing instructions for performing the functions and/or processes herein. For example, in some implementations, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for presenting a notification of playback availability are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

What is claimed is:

1. A method for presenting a notification indicating playback availability, comprising:
receiving interaction data corresponding to a user account authenticated on a first display device that is presenting a media content item, wherein the interaction data is associated with the first display device and a second display device;
determining a user type based on the received interaction data;
receiving local contextual data corresponding to the user account, wherein the local contextual data includes mobile application state information, media playback information, and connection information associated with the first display device and the second display device;
determining that a notification of playback availability from of plurality of notifications is to be presented on the first display device based at least in part on the received interaction data, the determined user type, and the received local contextual data; and
causing the notification to be presented on the first display device along with the media content item.

2. The method of claim 1, further comprising selecting a notification type from the plurality of notifications based at least in part on a device type associated with the first display device.

3. The method of claim 1, wherein the user type indicates a likelihood that the user will transfer playback of the media content item to the second display device.

4. The method of claim 1, wherein the media playback information included in the local contextual data indicates a resolution of the media content item.

5. The method of claim 1, wherein the connection data included in the local contextual data indicates a distance between the first display device and the second display device.

6. The method of claim 1, further comprising determining that a cursor associated with the first display device is positioned at a predetermined location of a display of the first display device, wherein the notification is presented in response to the determination.

7. The method of claim 1, further comprising:
determining that a predetermined duration of time has elapsed since the notification was presented on the first display device; and
in response to determining that the predetermined duration of time has elapsed, causing the notification to no longer be presented on the first display device.

8. A system for presenting a notification indicating playback availability, the system comprising:
a hardware processor that is programmed to:
receive interaction data corresponding to a user account authenticated on a first display device that is presenting a media content item, wherein the interaction data is associated with the first display device and a second display device;
determine a user type based on the received interaction data;
receive local contextual data corresponding to the user account, wherein the local contextual data includes mobile application state information, media playback information, and connection information associated with the first display device and the second display device;
determine that a notification of playback availability from of plurality of notifications is to be presented on the first display device based at least in part on the received interaction data, the determined user type, and the received local contextual data; and
cause the notification to be presented on the first display device along with the media content item.

9. The system of claim 8, wherein the hardware processor is further programmed to select a notification type from the plurality of notifications based at least in part on a device type associated with the first display device.

10. The system of claim 8, wherein the user type indicates a likelihood that the user will transfer playback of the media content item to the second display device.

11. The system of claim 8, wherein the media playback information included in the local contextual data indicates a resolution of the media content item.

12. The system of claim 8, wherein the connection data included in the local contextual data indicates a distance between the first display device and the second display device.

13. The system of claim 8, wherein the hardware processor is further programmed to determine that a cursor associated with the first display device is positioned at a predetermined location of a display of the first display device, wherein the notification is presented in response to the determination.

14. The system of claim 8, wherein the hardware processor is further programmed to:
determine that a predetermined duration of time has elapsed since the notification was presented on the first display device; and
in response to determining that the predetermined duration of time has elapsed, cause the notification to no longer be presented on the first display device.

15. A non-transitory computer-readable medium containing computer executable instructions that, when executed by a processor, cause the processor to perform a method for presenting a notification indicating playback availability, the method comprising:
receiving interaction data corresponding to a user account authenticated on a first display device that is presenting a media content item, wherein the interaction data is associated with the first display device and a second display device;
determining a user type based on the received interaction data;
receiving local contextual data corresponding to the user account, wherein the local contextual data includes mobile application state information, media playback information, and connection information associated with the first display device and the second display device;
determining that a notification of playback availability from of plurality of notifications is to be presented on the first display device based at least in part on the received interaction data, the determined user type, and the received local contextual data; and
causing the notification to be presented on the first display device along with the media content item.

16. The non-transitory computer-readable medium of claim 15, wherein the method further comprises selecting a notification type from the plurality of notifications based at least in part on a device type associated with the first display device.

17. The non-transitory computer-readable medium of claim 15, wherein the user type indicates a likelihood that the user will transfer playback of the media content item to the second display device.

18. The non-transitory computer-readable medium of claim 15, wherein the media playback information included in the local contextual data indicates a resolution of the media content item.

19. The non-transitory computer-readable medium of claim 15, wherein the connection data included in the local contextual data indicates a distance between the first display device and the second display device.

20. The non-transitory computer-readable medium of claim 15, wherein the method further comprises determining that a cursor associated with the first display device is positioned at a predetermined location of a display of the first display device, wherein the notification is presented in response to the determination.

21. The non-transitory computer-readable medium of claim 15, wherein the method further comprises:
determining that a predetermined duration of time has elapsed since the notification was presented on the first display device; and
in response to determining that the predetermined duration of time has elapsed, causing the notification to no longer be presented on the first display device.
